(19) United States
(12) Patent Application Publication
(10) Pub. No.: US 2021/0157638 A1
(43) Pub. Date: May 27, 2021

(54) METHOD AND APPARATUS FOR FUNCTIONAL UNIT ASSIGNMENT

(71) Applicants: Ehsan AMIRI, Thornhill (CA); Mikhail GUDIM, North York (CA); Ning XIE, Newmarket (CA)

(72) Inventors: Ehsan AMIRI, Thornhill (CA); Mikhail GUDIM, North York (CA); Ning XIE, Newmarket (CA)

(73) Assignee: HUAWEI TECHNOLOGIES CO., LTD., SHENZHEN (CN)

(21) Appl. No.: 16/692,844

(22) Filed: Nov. 22, 2019

(51) Int. Cl. G06F 9/48; G06F 9/30; G06F 9/50

(52) U.S. Cl. CPC G06F 9/4881; G06F 9/30098; G06F 9/5038; G06F 9/30145

(57) ABSTRACT

There is provided a method, apparatus and network node for determining an optimal functional unit for currently scheduled instructions. Embodiments divide the function unit assignment problem into separate assessments and subsequently reconciling any conflicts arising from different conclusions for the optimal functional unit. The separate assessments of the optimal functional unit relate to assessment of the optimal functional unit in terms of instruction bundling and the optimal functional unit in terms of latency. For the selection of the best functional unit in terms of instruction bundling, consideration regarding maximizing the size of instruction bundle is considered while taking into account the priority of instructions in the available queue. For the selection of the best functional unit in terms of latency, the most important successor of instruction node is primarily considered.

### FIELD OF THE TECHNOLOGY

The present disclosure pertains to compiler optimization, for example computer instruction scheduling, and in particular to a method and apparatus for functional unit assignment.

### BACKGROUND

In computer instruction scheduling, at least some instructions on chips, for example digital signal processor (DSP) chips, can be issued to two or three different functional units. As is known functional units can define a part of a processing unit that can perform operations and calculations. In such cases, the compilers, which translate computer code written in one language (e.g. high-level programming language) into another language (e.g. assembly language, object code or machine code), are responsible to select, among multiple candidates, a functional unit to which instructions should be assigned. In such cases, the compilers, which translate computer code written in one language (e.g. high-level programming language) into another language (e.g. assembly language, object code or machine code), are responsible to select, among multiple candidates, a functional unit to which instructions should be assigned (or to which instructions should be transmitted).

Functional unit selection is often a trade-off between instruction latency (e.g. the number of cycles for an instruction to have its data available for another instruction) and instruction level parallelism (e.g. a measure for the number of instructions that can be executed simultaneously in a computer program). Instructions issued to the same functional unit cannot be parallelized whereas instructions issued to different functional units can potentially be parallelized. Also, latency between an instruction and a predecessor or successor to that instruction may be changed if functional units to which the instructions are issued are changed.

A known manner for functional unit selection or assignment is known as cluster assignment. Two clustered DSPs are illustrated in FIG. 1. A clustered DSP is a DSP where the register file is partitioned into two or more subsets, namely register file 100 and register file 102. As shown in FIG. 1, each functional unit (FU) 104 . . . 117 has access to only one subset of all register files. A cluster can be defined as the register file and all functional units directly connected thereto. For example, in FIG. 1 register file 100 and the function units 104, 105, 106, 107 directly connected thereto can be considered a first cluster 110. Likewise, register file 102 and the function units 114, 115, 116, 117 directly connected thereto can be considered a second cluster 112.

In cluster assignment, when output of an instruction (i.e. a first instruction) is required by another instruction (i.e. a second instruction), for the second instruction to proceed (e.g. when data dependency exists between two instructions), the two instructions can be issued to two different clusters or the same cluster. When the instructions are issued to different clusters, the output of the first instruction must be copied to one of the registers in the other cluster (e.g. the cluster to which the second instruction is issued) in order for the second instruction to be performed. This will increase latency between the performance of the first instruction and the second instruction. To improve latency, the first and second instructions may be provided to the same cluster, however, it is not always desired to issue multiple instructions to the same cluster. For example, if too many instructions are issued to the same cluster, there may be instructions that are waiting in a queue until a functional unit becomes available for execution thereof, despite functional units in other clusters being available (e.g. in an idle state).

There have been attempts to resolve cluster assignment problems such as the method proposed by V. S. Lapinski, M. F. Jacome and G. A. De Veciana in “Cluster Assignment for High Performance Embedded VLIW Processors. ACM Transaction on Design Automation of Electronic Systems, Vol 7. No. 3, July 2002, Pages 430-454” and the method proposed by R. Leupers in “Instruction Scheduling for Clustered VLIW DSPs, Proceedings of International Conference on Parallel Architectures and Compilation Techniques. 2000”.

The method proposed by Lapinski is based on the fact that latency impact during cluster assignment typically has a symmetric nature. In other words, it is assumed that moving instructions from one cluster to another will take the same number of instruction cycles as moving instructions in the reverse direction. However, the method of Lapinski does not resolve cluster assignment problems for cases where the assumed symmetric nature does not exist.

The method proposed by Leupers can be considered to be complicated and require intensive compiling time. For example, the method of Leupers goes through a cluster assignment phase (e.g. a method using a simulated annealing algorithm) followed by an instruction scheduling phase. These two phases are repeated during the process until a fixed point (e.g. predetermined point) is reached. This repeated two-phase process can require rigorous implementation efforts as well as intensive compiling time.

Therefore there is a need for a method and apparatus for functional unit assignment that is not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method and apparatus for determining an optimal functional unit for one or more currently scheduled instructions. Embodiments divide the function unit assignment problem into separate assessments and subsequently reconciling any conflicts arising from different conclusions for the optimal functional unit. The separate assessments of the optimal functional unit relate to assessment of the optimal functional unit in terms of instruction bundling and the optimal functional unit in terms of latency. For the selection of the best functional unit in terms of instruction bundling, consideration regarding maximizing the size of instruction bundle is considered while taking into account the priority of instructions in the available queue. For the selection of the best functional unit in terms of latency, the most important successor of instruction node is primarily considered.

In accordance with embodiments of the present disclosure, there is provided a method for determining an optimal functional unit for one or more currently scheduled instructions. The method includes determining a first functional unit candidate based on a priority of one or more additional instructions in an available queue, the available queue including one or more instructions to be bundled with one or more currently scheduled instructions. The method further includes determining a second functional unit candidate based on a latency between the one or more currently scheduled instructions and a most important successor of the currently scheduled instructions and selecting the optimal functional unit from the first functional unit candidate and the second functional unit candidate.

According to some embodiments, the method further includes transmitting the one or more currently scheduled instructions to the optimal functional unit.

In accordance with embodiments of the present disclosure, there is provided an apparatus for determining an optimal functional unit for one or more currently scheduled instructions. The apparatus includes a processor and a memory storing thereon machine executable instructions. The machine executable instructions, when executed by the processor cause the apparatus to determine a first functional unit candidate based on a priority of one or more additional instructions in an available queue, the available queue including one or more instructions to be bundled with one or more currently scheduled instructions. The machine executable instructions, when executed by the processor further cause the apparatus to determine a second functional unit candidate based on a latency between the one or more currently scheduled instructions and a most important successor of the currently scheduled instructions and select the optimal functional unit from the first functional unit candidate and the second functional unit candidate.

According to some embodiments, the machine executable instructions, when executed by the processor further cause the apparatus to transmit the one or more currently scheduled instructions to the optimal functional unit.

In accordance with embodiments of the present disclosure, there is provided a network node for determining an optimal functional unit for one or more currently scheduled instructions. The network node includes a processor and a memory storing thereon machine executable instructions. The machine executable instructions, when executed by the processor cause the network node to determine a first functional unit candidate based on a priority of one or more additional instructions in an available queue, the available queue including one or more instructions to be bundled with one or more currently scheduled instructions. The machine executable instructions, when executed by the processor further cause the network node to determine a second functional unit candidate based on a latency between the one or more currently scheduled instructions and a most important successor of the currently scheduled instructions and select the optimal functional unit from the first functional unit candidate and the second functional unit candidate.

In some embodiments, the machine executable instructions, when executed by the processor further cause the network node to transmit the one or more currently scheduled instructions to the optimal functional unit.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates a cluster configuration in accordance with the prior art.

FIGS. 2A to 2D illustrate example scenarios for instruction assignment to functional units in accordance with embodiments.

FIG. 3 illustrates, in a flow diagram, a procedure of selecting a desired functional unit in terms of instruction bundling, in accordance with embodiments.

FIG. 4 illustrates, in a flow diagram, a procedure of selecting a desired functional unit in terms of latency, in accordance with embodiments.

FIG. 5 illustrates, in a flow diagram, a procedure for resolving conflicts if the desired functional unit selected for instruction bundling and the desired functional unit selected for latency are different, in accordance with embodiments.

FIG. 6 illustrates, in a schematic diagram, an electronic device in accordance with embodiments.

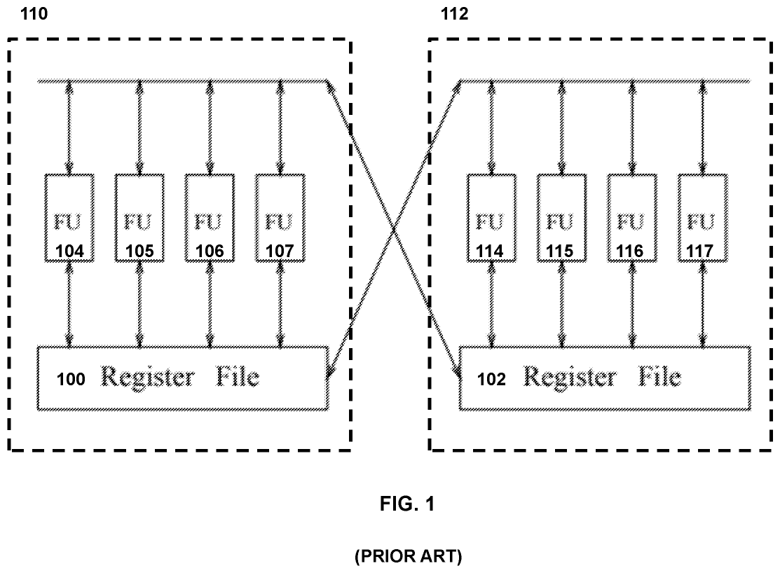

It will be noted that throughout the appended drawings, like features are identified by like reference numerals.

### DETAILED DESCRIPTION

As used herein, the term “instruction” refers to a computer instruction or a single operation containing step(s) to be executed by a computer processor.

Unless defined otherwise, all technical and scientific terms used herein have the same meaning as commonly understood by one of ordinary skill in the art to which this invention belongs.

In computer science or computer engineering, instruction scheduling is one way of optimizing compiler to improve performance of the computer program on the machine while producing an equivalent output and not changing the meaning of computer source code. To improve the performance, some instructions on chips (e.g. digital signal processor (DSP) chips) may be issued to two or three different functional units, which can define a part of a processing unit that can perform the operations or calculations. In such cases, the compilers are responsible for selecting, among multiple candidates, a functional unit to which instructions should be assigned.

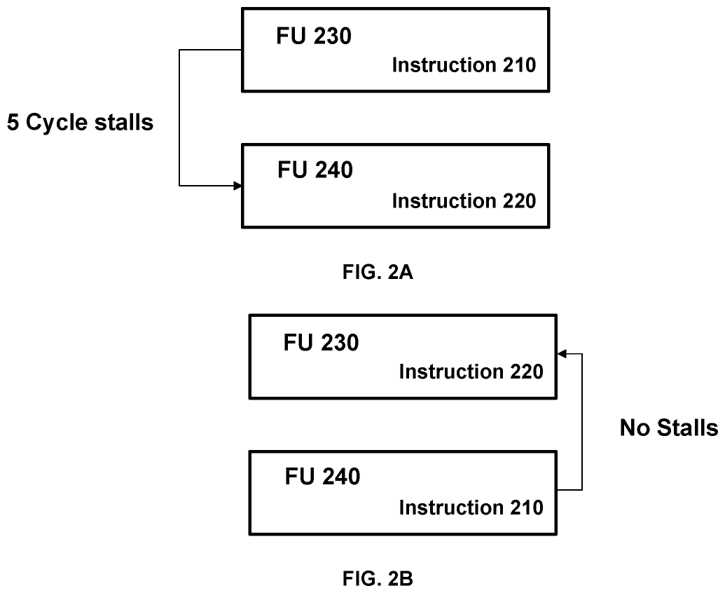

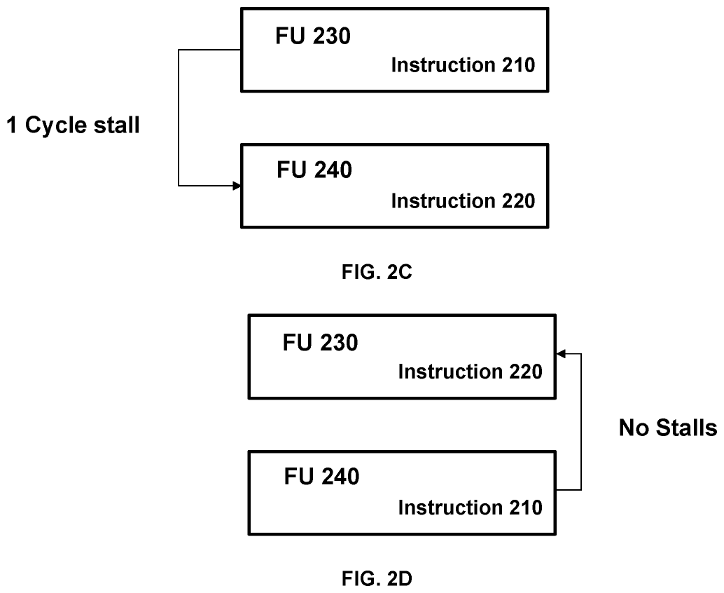

As stated above, a known manner for functional unit selection or assignment is known as cluster assignment. As is known a cluster assignment problem may include cases having an asymmetric nature. In such cases, there may be no clustering of functional units and register files, and all functional units have access to all register files. However, the result being forwarded from one instruction to another instruction may vary significantly from one functional unit to another. FIGS. 2A to 2D illustrate example scenarios for instruction assignment to functional units in accordance with embodiments. For example, consider an asymmetry in cycle stalls between two functional units. Referring to FIG. 2A, in a first case, instruction 210 may be issued to functional unit 230 and instruction 220 may be issued to functional unit 240. Instruction 210 may be issued to functional unit 230 first and then instruction 220 may be issued to functional unit 240 later as instruction 220 has data dependency upon instruction 210. In this assignment scenario, there may be five (5) cycle stalls between the execution of instruction 210 and the execution of instruction 220. In another case, as illustrated in FIG. 2B, instruction 210 may be issued to functional unit 240 and instruction 220 may be issued to functional unit 230. Despite still having a data dependency between these two instructions (e.g. instruction 220 has a data dependency upon instruction 210), there may be no cycle stalls between the execution of instruction 210 and the execution of instruction 220. In this scenario, it would be understood that the assignment of the instructions provided in FIG. 2B may be desired in order to execute both instructions in the shortest time frame.

Compilers that are responsible for selecting functional units have variations of the functional unit assignment problem, such as the example illustrated above. Currently available solutions may give high priority to latency (e.g. the number of cycles for an instruction to have its data available for another instruction) compared to instruction level parallelism and use a type of heuristic method to avoid bad instruction bundling. Such solutions can provide low instruction level parallelism.

However, there exist other variations of the cluster assignment scenarios that require solutions to make more subtle decisions. For example, there may exist a variation of the cluster assignment scenarios that is substantially equivalent to the case illustrated in FIGS. 2A and 2B except that there exists a subtle difference in number of cycle stalls between two instructions. This variation of the cluster assignment scenario is illustrated in FIGS. 2C-2D. As illustrated in FIG. 2C, there exists only single (1) cycle stall, instead of five (5) cycle stalls, between FU 230 and FU 240, when transferring data results from an instruction from FU 230 to FU 240. FIG. 2D illustrates that assuming having a data dependency between these two instructions (e.g. instruction 220 has a data dependency upon instruction 210), there is no cycle stalls between the execution of instruction 210 and the execution of instruction 220. FIG. 2D is substantially equivalent to FIG. 2B. In such cases, currently available solutions or currently available techniques from cluster assignment may not be applicable due to asymmetry. Also, currently available rough heuristic methods that simply avoid bad instruction bundling may not be applicable as favouring one aspect (e.g. instruction latency) over the other (e.g. instruction level parallelism) may not be acceptable. By simply favouring instruction latency (e.g. the number of cycles for an instruction to have its data available for another instruction), the other aspect (e.g. instruction level parallelism) may be negatively affected to the same extent that instruction latency is enhanced. Therefore, in this type of case, both instruction latency and instruction level parallelism should be sufficiently contemplated in order to at least in part improve overall performance for functional unit assignment.

It should be also noted that other issues such as phase ordering need to be considered for compiler optimization, specifically when selecting an optimal functional unit to which instructions should be assigned. For example, if an optimal functional unit is determined before instruction scheduling, instruction latency between two instructions can be enhanced at the potential cost of bad instruction bundling and ineffective instruction level parallelism. In such cases, two linked instructions may be placed far from each other through instruction scheduling, thereby rendering efforts for optimal functional unit assignment at least partially ineffective, due to latency of transmission between the functional units. On the other hand, if an optimal functional unit is determined after instruction scheduling, the latency between two instructions may be adjusted after instruction scheduling, thereby reducing the effect of having inaccurate instruction scheduling processes.

According to embodiments, there is provided a method and an apparatus for determining an optimal functional unit for one or more currently scheduled instructions. The optimal functional unit may refer to a most favorable functional unit, in terms of performance enhancement, to which currently scheduled instructions can be assigned, among all available functional units. The optimal functional unit may or may not be the best possible functional unit choice in all conditions. Issues with respect to optimal functional unit assignment may be resolved using a heuristic method simultaneously with post register allocation (RA) instruction scheduling (e.g. after register allocation). With regard to the currently scheduled instructions, in some embodiments, the one or more currently scheduled instructions are a very long instruction word (VLIW). The VLIW refers to an instruction set architecture designed to break computer instruction into basic operations that can be executed by the processor in parallel.

Embodiments may be implemented as a post RA instruction scheduler. As such, the method for determining optimal functional unit assignment may be implemented as part of post RA instruction scheduling. This may allow embodiments to have accurate information about code, such as expanded pseudo instructions for which the register allocation is done. The implementation may also enable reuse of existing data structures and code such as the available queue.

When implementing as part of post RA instruction scheduling, post RA node ordering may be relied upon for instruction node ordering. Post RA node ordering may provide information about candidate instructions that are likely to be packetized in the current instruction bundle (e.g. a set of instructions grouped together as a bundle), by looking into the available queue. Such information may not be available if only instructions on the critical path, the longest series of operations or instructions that needs to be executed sequentially due to data dependencies, are explored. The information may also not be accurate if a different node ordering (i.e. node ordering different from post RA node ordering) is relied upon. Post RA node ordering may also remove or mitigate phase ordering issues where an earlier phase working with inaccurate information can be potentially invalidated by the later phase.

There has been an implementation of a scheduling method as an extension of instruction scheduler for clustered architecture, for example a method proposed by Ozer, Banerjia and Conte (E. Ozer, S. Banerjia, T. M. Conte, “Unified assign and schedule: A new approach to scheduling for clustered register file microarchitectures”, Proc. 31th Annu. Int. Symp. Microarchitecture, pp. 308-314, 1998-November) which defined a unified-assign-and-schedule (UAS), which merges the cluster assignment and instruction scheduling phases, was. However, there was not consideration for the most important successor of each instruction node and the movability thereof. There was also no discussion of factors to consider (e.g. movability of the most important successor and movability of instruction(s) that can be bundled with the currently scheduled instruction) for resolving a conflict arising from different recommendations for the functional unit assignment.

In instruction scheduling, a data structure called the available queue may be required. The available queue may include the list of all instructions that are ready to be scheduled, and the instruction nodes in the available queue may be nodes whose dependencies are already scheduled and with results ready for use in subsequent instructions. According to embodiments, there is provided a method and apparatus that takes advantage of this data structure to make better predictions regarding the impact of decisions.

Embodiments provide a method which considers the instructions with highest priority in the available queue. It should be noted that priority can be indicative of being regarded as more important than others or being proceeded before others. For example, the instruction with highest priority may be the most important and critical instruction or the instruction to be proceeded first. According to embodiment, three phases of the method include (i) choosing, among all choices of functional units, the best functional unit for instruction bundling, (ii) choosing, among all choices of functional units, the best functional unit for latency, and (iii) resolving conflicts if the chosen functional units derived from the phases (i) and (ii) are different or contradictory.

A challenge for the determination of a three-phase (heuristic) method is associated with the extent of complexity applied to the method. For instance, if the method is configured too simply, there can be too many conflicts that arise between the functional units selected in the phases (i) and (ii) (e.g. the functional unit selected in the phase (i) is different from the functional unit selected in the phase (ii)). Alternately, if the method is configured to be overly complicated, the amount of effort required to implement such a method may be excessively large and thus may require intensive compile time.

As noted above, the method can be configured to identify the highest priority node (e.g. instruction node with highest priority) from the available queue. When identifying or determining the node with the highest priority from the available queue, whether there exists one or more, alternative instruction nodes may be also investigated. Each of the alternative instruction nodes may be considered with respect to their respective impact for latency and instruction bundling. The most appropriate instruction node may be selected based on this consideration.

Once the highest priority instruction node is selected from the available queue, an inspection for a resource hazard may performed. If there is no resource hazard (e.g. the same resource is not needed by two or more instructions at the same time), the highest priority instruction node identified may be scheduled. Alternately, if a resource hazard exists for the highest priority instruction node, another instruction node (e.g. a node with the next highest priority) may be identified and inspected to determine whether there is a resource hazard associated therewith. This evaluation may be repeated until an appropriate instruction node is identified and scheduled. Once an instruction node is scheduled, data structures such as available queue, pending queue and cycle, may be updated.

As defined above, the method for determining an optimal functional unit for one or more currently scheduled instructions may have three phases—(i) choosing, among all choices of functional units, the best functional unit for instruction bundling, (ii) choosing, among all choices of functional units, the best functional unit for latency, and (iii) resolving conflicts if the chosen functional unit derived from the phases (i) and (ii) are different from or contradictory to each other. Each of these phases will be further described below with details.

According to embodiments, the method can be applied to an in-order processor where the compiler can determine the functional unit to which an instruction is issued. Generally, this represents the characteristics of digital signal processors (DSPs). In various embodiments, the overall framework of the method can be used for other architectures with minor modifications. Adjustment in the heuristic method may be required depending on computing system architecture characteristics.

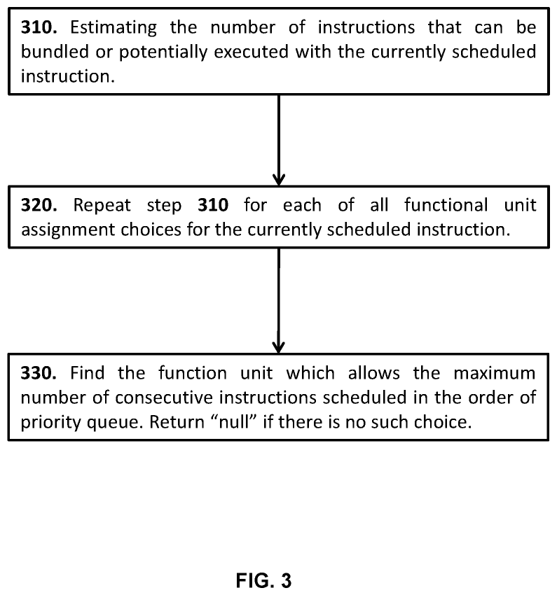

FIG. 3 illustrates, in a flow diagram, a procedure of selecting the best functional unit among choices of functional units in terms of instruction bundling, in accordance with embodiments. FIG. 3 illustrates phase (i) of the method for determining an optimal functional unit. For this phase (i.e. when determining the best functional unit in terms of instruction bundling), it is assumed that an available queue exists during post RA scheduling and the available queue contains an ordered list of instructions that are ready to be scheduled.

According to embodiments, the number of instructions that can be bundled with the currently scheduled instruction may be estimated for each of the potential functional units that can be assigned to the currently scheduled instruction. It should be noted that multiple instructions can be grouped together as a bundle. Bundled instructions may be executed in parallel. Instructions in the instruction bundle may not have conflicting dependencies. To obtain a proper list of eligible instructions that can be bundled with the currently scheduled instruction, all instructions in the available queue may be considered. In some embodiments, at least some of the successors in the available queue may be also considered because, for example, architecture of some computing systems may support bundling anti-dependencies and/or data dependencies under certain conditions.

According to embodiments, for each potential functional unit, each of all the instructions in the available queue may be examined in order to create a list of all eligible instructions that can be bundled with the currently scheduled instruction. The examination of the instructions may be performed individually (e.g. one by one) as long as the instruction being examined can be bundled with the currently scheduled instruction. In some embodiments, if the instructions being examined cannot be bundled with the currently scheduled instruction, other instructions from the available queue may be examined to see if they can be bundled with the currently scheduled instruction. According to some embodiments, during this examination or evaluation, only one instruction in the available queue and its successors may be examined at a time. In some embodiments, information regarding which instructions can be bundled with the currently scheduled instruction may be stored in order to save compile time. In some embodiments, the examination may consider cases where the instruction can be bundled with the currently scheduled instruction upon reassignment of the current instruction to a different functional unit.

According to embodiments, the method for finding an optimal functional unit does not focus solely on the number of instructions that can be bundled with the currently scheduled instruction. One or more other factors including priority can be considered during the identification of an optimal functional unit.

According to embodiments, the examination may stop when the instruction being examined cannot be bundled with the currently scheduled instruction. In other words, for each functional unit, the number of instructions that can be bundled with the currently scheduled instruction may be determined upon the identification of a first instruction that cannot be bundled with the currently scheduled instruction.

As noted above, the examination may stop when the instruction being examined cannot be bundled with the currently scheduled instruction. Two cases be considered in this regard. The first case is that only one instruction can be additionally bundled with the currently scheduled instruction and this instruction is on the critical path. The other case is that there are multiple instructions that can be bundled with the currently scheduled instruction but these instructions have large movability. According to embodiments, the movability of an instruction (i.e. an instruction node) can be indicative of the ease with which an instruction can be moved. According to embodiments, further defined elsewhere, movability of an instruction can be determined based on one or more factors, for example length of critical path, depth of the instruction node and height of the instruction node. According to embodiments, the instruction identified in the first case is preferred among these two cases. In other words, priority of an instruction may be regarded as more important than the number of instructions that can be bundled. As such, in various embodiments, the available queue is ordered in terms of priority. With the available queue ordered in priority, the examination of instructions for bundling can be stopped upon the identification of the first instruction that cannot be bundled with the currently scheduled instruction. It can be noted that the other instructions, namely instructions subsequent to the first instruction that cannot be bundled, do not need to be examined, as the other instructions have lower priorities.

According to embodiments, output of phase (i) is a recommended functional unit that is desired to improve instruction bundling. Specifically, upon completing the steps above, the number of instructions that can be bundled with the currently scheduled instruction will be estimated for each of the available functional units. The recommended functional unit from phase (i) would be the functional unit estimated to have the largest number of instructions that can be bundled with the currently scheduled instruction. If all available functional units are estimated to have the same number of instructions that can be bundled with the currently scheduled instruction (i.e. no difference between functional units), then there will be no recommended functional unit at phase (i) and the output of the phase (i) will be null.

Steps to find the best functional unit that allows for the maximum number consecutive instructions (i.e. phase (i)) will be further described below with reference to FIG. 3. As illustrated in FIG. 3, step 310 includes estimating the number of instructions that can be bundled or potentially executed with the currently scheduled instruction. All instructions in the available queue will be examined to determine whether one or more of these instructions can be bundled with the currently scheduled instruction. The instructions in the available queue may be arranged in order of priority. In addition, successors of the instructions from the available queue may be also considered. According to embodiments, the successor instructions may or may not be considered depending on the architecture of the computing system as the architecture of the computing system may or may not support bundling anti-dependencies and/or data dependencies under certain conditions.

At step 310, each of the instructions in the available queue and their successors may be individually examined to determine if the instruction can be bundled with the currently scheduled instruction. According to some embodiments, during this examination, only one instruction in the available queue and the successors thereof may be examined at a time.

According to embodiments, the number of instructions that can be bundled with the currently scheduled instruction is estimated in association with one of the functional units that can be assigned to the instructions at a time. As such, at step 320, step 310 is repeatedly performed, for each of the functional unit assignment choices for the currently scheduled instruction.

When the number of instructions that can be bundled with the currently scheduled instruction is estimated for all functional unit assignment choices, the best functional unit will be determined, at step 330, such that the best functional unit allows the maximum number of instructions (e.g. consecutive instructions) to be bundled with the currently scheduled instruction. A ‘Null’, for example a non-selection of a functional unit, will be returned from phase (i) if there is no such functional unit assignment choice or all potential functional unit assignment choices will allow the same number of instructions to be bundled with the currently scheduled instruction.

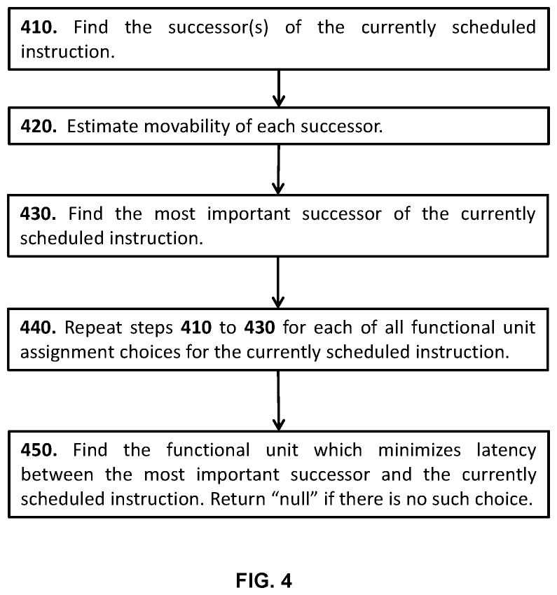

FIG. 4 illustrates, in a flow diagram, a procedure of selecting the best functional unit among all choices of functional units in terms of latency, in accordance with embodiments. FIG. 4 illustrates phase (ii) of the method for determining an optimal functional unit.

According to embodiments, all potential functional units that can be assigned to the currently scheduled instruction may be examined to determine the best functional unit in terms of latency. In various embodiments, the best functional unit in terms of latency may be determined based on the latency between the currently scheduled instruction and its successor. When there are multiple successors for the currently scheduled instruction, only the most important successor may be considered. According to embodiments, the most important successor may be a successor with the lowest or smallest movability. The movability of an instruction (i.e. instruction node) is determined based on one or more factors, for example length of critical path, depth of the instruction node and height of the instruction node. According to some embodiments, movability can be determined as follows:

Movability=length of critical path−depth of the instruction node−height of the instruction node

When defining the movability of an instruction node as above, every instruction node on the critical path will have zero movability whereas other instruction nodes, for example instruction node not on the critical path, have movability of one (1) or greater.

According to embodiments, any predecessors of the currently scheduled instruction may not be considered to determine the best functional unit in terms of latency. As the optimal functional unit will be determined during post RA scheduling and predecessors are already scheduled, performing any scheduling tasks for predecessors cannot be performed. Moreover, the benefits of determining the optimal functional unit during post RA scheduling will be greater than the loss due to not fine-tuning the method for determining an optimal functional unit.

According to embodiments, the optimal functional unit determined at this phase (i.e. phase (ii)) will be the functional unit that minimizes latency between the currently scheduled instruction and its most important successor.

Steps to find the best functional unit in terms of latency (i.e. phase (ii)) will be further described below with reference to FIG. 4. Step 410 includes finding the successor(s) of the currently scheduled instruction. There may be one successor or multiple successors for the currently scheduled instruction. At step 420, movability of each successor may be estimated. In some embodiments, movability of each successor determined, at step 420, can be based on one or more factors, for example length of critical the path, depth of the instruction node and height of the instruction node (e.g. movability=length of critical path−depth of the instruction node−height of the instruction node).

Upon the estimation of the movability of each successor for the currently scheduled instruction, the most important successor of the currently scheduled instruction may be found at step 430. The most important successor may be the successor with the lowest or smallest movability.

According to embodiments, the most important successor of the currently scheduled instruction is determined based on one functional unit at a time. As such, steps 410 to 430 are repeatedly performed, (step 440), for each of the functional unit assignment choices for the currently scheduled instruction.

Once the most important successor of the currently scheduled instruction is found for all functional unit assignment choices, the best functional unit will be determined, at step 450, such that the best functional unit minimizes latency between the most important successor (e.g. the successor with the lowest movability) and the currently scheduled instruction. A ‘Null’, for example a non-selection of a functional unit, will be returned from phase (ii) if there is no such functional unit assignment choice or latency between the most important successor (e.g. the successor with the lowest movability) and the currently scheduled instruction is same for all functional assignment choices.

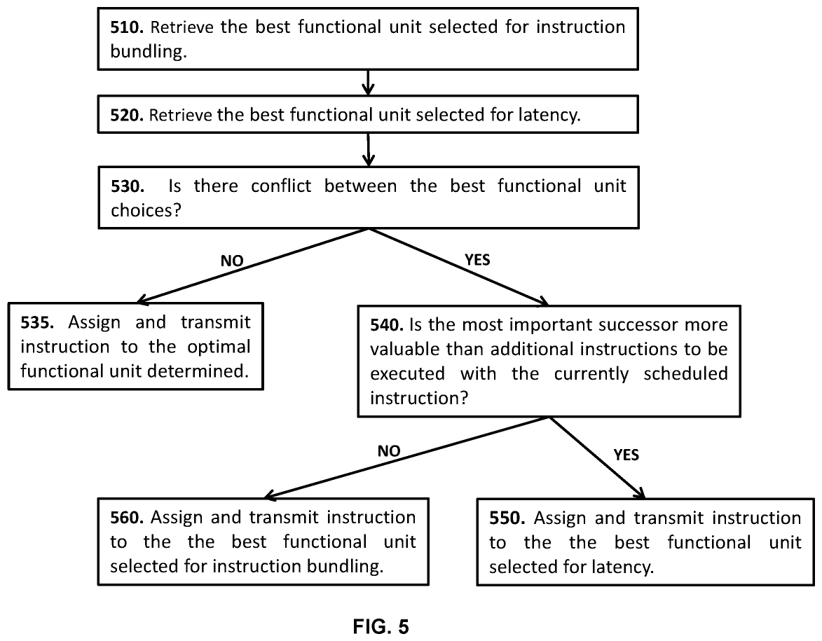

FIG. 5 illustrates, in a flow diagram, a procedure for resolving conflicts if the best functional unit selected for instruction bundling and the best functional unit selected for latency are different, in accordance with embodiments. FIG. 5 illustrates phase (iii) of the method for determining an optimal functional unit.

According to embodiments, the optimal functional unit will be determined based on the recommended functional units from earlier phases (i.e. phases (i) and (ii)). If the best functional unit determined by phase (i) and (ii) is the same, this functional unit will be the optimal functional unit for the currently scheduled instruction. If the best functional unit determined at phase (i) is different from the best function unit determined at phase (ii), then one of these recommended functional units may be selected.

For example, among the instructions that can be bundled with the currently scheduled instruction, one or more instructions may be selected such that they can be bundled with the currently scheduled instruction when assigning the best functional unit in terms of instruction bundling (i.e. the best functional unit determined at phase (i)) but cannot be bundled when assigning the best functional unit for latency (i.e. the best functional unit determined at phase (ii)). In this instance, movability may be determined for each of these selected instructions. Upon determining movability for each of the instructions, the instruction with the lowest movability would be compared with the movability of the most important successor of the currently scheduled instruction. Based on the movability comparison, the optimal functional unit to be assigned to the currently scheduled instruction will be determined based on the lowest movability.

Final steps to determine the optimal functional unit (i.e. phase (iii)) will be further described below with reference to FIG. 5. At step 510 the best functional unit selected for instruction bundling may be retrieved and at step 520 the best functional unit selected for latency may be retrieved. At step 530, the existence of a conflict between the best functional unit selected for instruction bundling and the best functional unit selected for latency can be determined. If the best functional unit selected for instruction bundling is the same as the best functional unit selected for latency (i.e. no conflict), this selected functional unit is the optimal functional unit for the currently scheduled instruction. In this case, at step 535 the determined optimal functional unit may be assigned to the currently scheduled instruction and the currently scheduled instruction or one or more operations contained in the currently scheduled instruction (e.g. operation contained in the VLIW) is transmitted to the determined optimal functional unit.

If the best functional unit selected for instruction bundling is different from the best functional unit selected for latency (i.e. conflict exists), then at step 540 it is evaluated whether the most important successor of the currently scheduled instruction which is identified at phase (ii) is more valuable than the additional instructions to be executed with the currently scheduled instruction that are identified at phase (i). In various embodiments, this may be determined based on the movability of the most important successor identified at phase (ii) and the movability of the most important instruction among the additional instructions that is identified at phase (i) but cannot be bundled with the currently scheduled instruction if the best functional unit selected for latency is assigned. At step 550, if the most important successor of the currently scheduled instruction is more valuable than the additional instructions to be executed with the currently scheduled instruction, the best functional unit selected for latency will be determined as the optimal functional unit and assigned to the currently scheduled instruction. Further at step 550, the currently scheduled instruction or one or more operations contained in the currently scheduled instruction (e.g. operation contained in the VLIW) will be transmitted to the determined optimal functional unit. On the contrary, if the additional instructions to be executed with the currently scheduled instruction are more valuable than the most important successor of the currently scheduled instruction, at step 560, the best functional unit selected for instruction bundling will be determined as the optimal functional unit and assigned to the currently scheduled instruction. Further at step 560, the currently scheduled instruction or one or more operations contained in the currently scheduled instruction (e.g. operation contained in the VLIW) will be transmitted to the determined optimal functional unit.

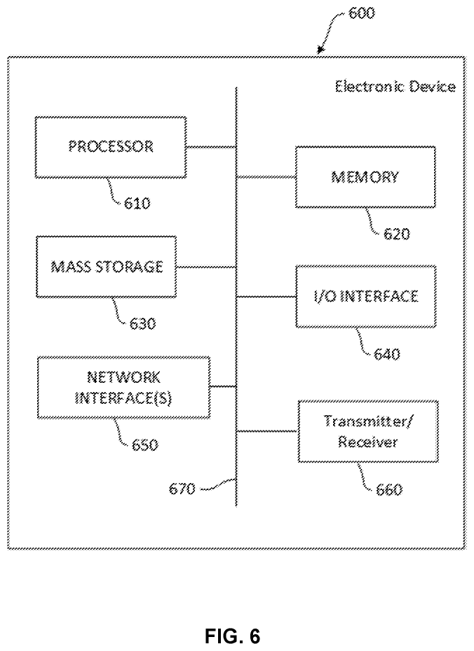

FIG. 6 is a schematic diagram of an electronic device 600 that may perform any or all of operations of the above methods and features explicitly or implicitly described herein, according to different embodiments. For example, a computing device may be configured as electronic device 600. Further, a network element executing digital signal processing may be configured as the electronic device 600.

As shown, the device includes a processor 610, memory 620, non-transitory mass storage 630, I/O interface 640, network interface 650, and a transceiver 660, all of which are communicatively coupled via bi-directional bus 670. According to certain embodiments, any or all of the depicted elements may be utilized, or only a subset of the elements. Further, the device 600 may contain multiple instances of certain elements, such as multiple processors (e.g. general-purpose microprocessors such as CPU and/or specialized microprocessors such as digital signal processor or other processing units or devices as would be readily understood), memories, or transceivers. Also, elements of the hardware device may be directly coupled to other elements without the bi-directional bus. Additionally or alternatively to a processor and memory, other electronics, such as integrated circuits, may be employed for performing the required logical operations.

The memory 620 may include any type of non-transitory memory such as static random access memory (SRAM), dynamic random access memory (DRAM), synchronous DRAM (SDRAM), read-only memory (ROM), any combination of such, or the like. The mass storage element 630 may include any type of non-transitory storage device, such as a solid state drive, hard disk drive, a magnetic disk drive, an optical disk drive, USB drive, or any computer program product configured to store data and machine executable program code. According to certain embodiments, the memory 620 or mass storage 630 may have recorded thereon statements and instructions executable by the processor 610 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

It is obvious that the foregoing embodiments of the present disclosure are examples and can be varied in many ways. Such present or future variations are not to be regarded as a departure from the spirit and scope of the disclosure, and all such modifications as would be obvious to one skilled in the art are intended to be included within the scope of the following claims.

We claim:

1. A method for determining an optimal functional unit for one or more currently scheduled instructions, the method comprising:
determining a first functional unit candidate based on a priority of one or more additional instructions in an available queue, the available queue including one or more instructions to be bundled with one or more currently scheduled instructions;
determining a second functional unit candidate based on a latency between the one or more currently scheduled instructions and a most important successor of the currently scheduled instructions; and
selecting the optimal functional unit from the first functional unit candidate and the second functional unit candidate.

2. The method of claim 1, wherein the method further comprises:
transmitting the one or more currently scheduled instructions to the optimal functional unit.

3. The method of claim 1, wherein the first functional unit candidate is selected further based on number of the additional instructions allowed to be bundled with the one or more currently scheduled instructions.

4. The method of claim 1, wherein the one or more additional instructions are arranged in order of priority.

5. The method of claim 1, wherein the most important successor is a successor of the one or more currently scheduled instructions with a smallest movability.

6. The method of claim 1, wherein the first functional unit candidate equates to the second functional unit candidate.

7. The method of claim 1, wherein the optimal functional unit is selected based on a comparison of a movability of the one or more additional instructions and a movability of the most important successor.

8. The method of claim 1, wherein the optimal functional unit is determined during post-register-allocation scheduling.

9. The method of claim 1, wherein the one or more currently scheduled instructions are a very long instruction word.

10. An apparatus for determining an optimal functional unit for one or more currently scheduled instructions, the apparatus comprising:
a processor; and
a memory storing thereon machine executable instructions, which when executed by the processor configure the apparatus to:
determine a first functional unit candidate based on a priority of one or more additional instructions in an available queue, the available queue including one or more instructions to be bundled with one or more currently scheduled instructions;
determine a second functional unit candidate based on a latency between the one or more currently scheduled instructions and a most important successor of the currently scheduled instructions; and
select the optimal functional unit from the first functional unit candidate and the second functional unit candidate.

11. The apparatus according to claim 10, wherein the instructions when executed by the processor further configure the apparatus to:
transmit the one or more currently scheduled instructions to the optimal functional unit.

12. The apparatus of claim 10, the first functional unit candidate is selected further based on number of the additional instructions allowed to be bundled with the one or more currently scheduled instructions.

13. The apparatus of claim 10, wherein the one or more additional instructions are arranged in order of priority.

14. The apparatus of claim 10, wherein the most important successor is a successor of the one or more currently scheduled instructions with a smallest movability.

15. The apparatus of claim 10, wherein the first functional unit candidate equates to the second functional unit candidate.

16. The apparatus of claim 10, wherein the optimal functional unit is selected based on a comparison of a movability of the one or more additional instructions and a movability of the most important successor.

17. The apparatus of claim 10, wherein the optimal functional unit is determined during post-register-allocation scheduling.

18. The apparatus of claim 10, wherein the one or more currently scheduled instructions are a very long instruction word.

19. A network node for determining an optimal functional unit for one or more currently scheduled instructions, the network node comprising:
a network interface for receiving data from and transmitting data to components connected to a computing network;
a processor; and
a memory storing thereon machine executable instructions, which when executed by the processor configure the network node to:
determine a first functional unit candidate based on a priority of one or more additional instructions in an available queue, the available queue including one or more instructions to be bundled with one or more currently scheduled instructions;
determine a second functional unit candidate based on a latency between the one or more currently scheduled instructions and a most important successor of the currently scheduled instructions;
select the optimal functional unit from the first functional unit candidate and the second functional unit candidate;
transmit the one or more currently scheduled instructions to the optimal functional unit.

20. The network node according to claim 19, wherein the instructions when executed by the processor further configure the network node to:
transmit the one or more currently scheduled instructions to the optimal functional unit.
